(19) United States
(12) Patent Application Publication
(10) Pub. No.: US 2012/0055600 A1
(43) Pub. Date: Mar. 8, 2012

(54) WHEEL COVER

(76) Inventors: Brian Brown, Sleepy Hollow, NY (US); Jake Devries, Palatine, IL (US); Douglas E. Brown, Sleepy Hollow, NY (US)

(21) Appl. No.: 13/225,196

(22) Filed: Sep. 2, 2011

Related U.S. Application Data
(60) Provisional application No. 61/379,623, filed on Sep. 2, 2010.

(51) Int. Cl. B60C 27/00

(52) U.S. Cl. 152/187

(57) ABSTRACT

A skateboard wheel cover includes a circumferential lip, an inner surface connected to an inner portion of the circumferential lip, and an outer surface connected to an outer portion of the circumferential lip. The outer surface is a material with a durometer different than a durometer of the wheel. The cover further includes at least a first attachment device configured to selectively attach to a skateboard wheel.

### RELATED APPLICATIONS

This application claims the benefit of, and priority to, U.S. Provisional Patent Application 61/379,623 filed Sep. 2, 2010. The entirety of that application is incorporated by reference herein.

### TECHNICAL FIELD

This invention relates generally to skateboards. The invention more particularly relates to covers for skateboard wheels.

### BACKGROUND OF THE INVENTION

A typical skateboard wheel is a hard urethane wheel in a small size diameter (e.g., 53 mm, 55 mm or similar) for a greater ease of performing skateboard maneuvers. While great for tricks and maneuvers, a small and hard set of wheels is not an efficient means of transportation beyond the local skating area. Street skateboard wheels are hard, noisy and slow when encountering rough terrain and can be challenging to control if riding in an area with small pebbles or debris.

Multiple models of skateboard wheels are available, including wheels that are softer than typical street skateboard wheels. However, obtaining the benefits of these softer wheels requires removing the other wheels and replacing them—a time consuming project.

Therefore, it would be desirable to provide an apparatus and method that overcomes the aforementioned and other disadvantages.

### BRIEF DESCRIPTION OF THE DRAWINGS

The figures illustrate a number of views of the invention.

FIG. 1 illustrates a side view of an attachment unit, in accordance with one aspect of the invention;

FIG. 2 illustrates a side view of an attachment unit, in accordance with another aspect of the invention;

FIG. 3 illustrates a side view of an attachment unit, in accordance with another aspect of the invention;

FIG. 4 illustrates a side view of an attachment unit, in accordance with another aspect of the invention;

FIG. 5A, 5B, 5C illustrates a side view of an attachment unit, in accordance with another aspect of the invention;

FIG. 6 illustrates a perspective view of an attachment unit, in accordance with another aspect of the invention; and

FIGS. 7 and 8 illustrate perspective views of attachment units, in accordance with another aspect of the invention.

### DETAILED DESCRIPTION OF THE PRESENTLY PREFERRED EMBODIMENTS

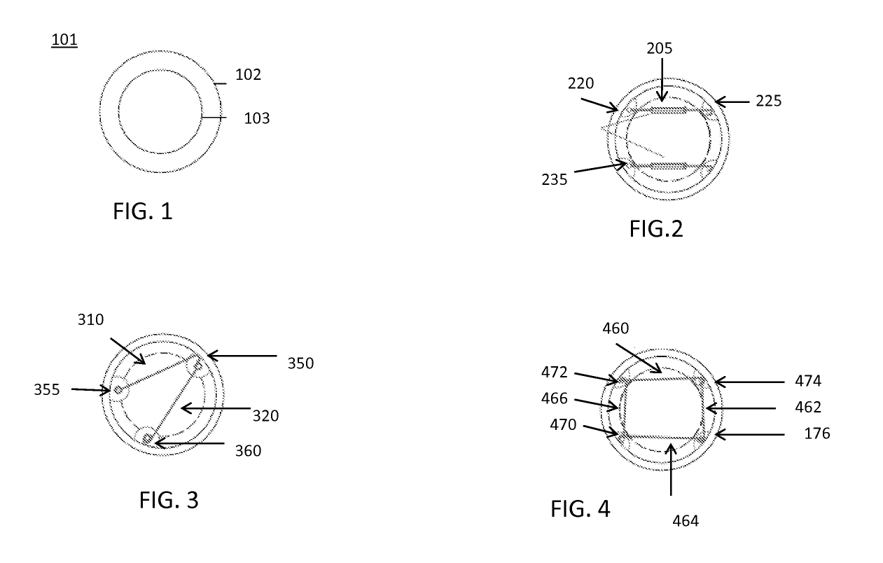

In general, the invention provides, as seen in FIG. 1, a slip-on attachment unit 101 that will engage the periphery of the wheels of a skateboard to convert the surface contacting portion of the wheels into a different wheel durometer. By slipping on the cover 101, the wheels will be adapted for use on rougher terrain and also allow the user to ride the same or similar terrain as they do with typical skateboard wheels in a faster, smoother, quieter manner. The slip-on attachment unit comprises in general a generally hollow cylindrical attachment member 102 which is adapted to fit over and frictionally engage the ground contacting periphery of the conventional skateboard wheels with an interior surface 103. In preferred embodiments, the wheel will not be restrained from rotation about its related axle. Furthermore, the design and construction of the slip-on attachment unit will allow a skateboard to be converted quickly without removing the wheels from the skateboard and without any particular degree of manual dexterity. Conversely, the skateboard may be returned to its normal configuration in a like manner and without a great deal of physical exertion.

In particular, FIG. 1 illustrates that the wheel cover includes a substantially cylindrical profile including a circumferential lip 104 along one end of the cylinder and attachment members (FIG. 3, etc) on the other end of the cylinder. The material for the cover is, in one embodiment, a softer durometer than the relatively hard durometer of many skateboard wheels. In such embodiments, the material is more flexible and allows the cover to ‘slide’ over the wheel by rotating or bending the attachment members out of the way, slipping the cover over the wheel, and allowing the attachment members to resume their preferred position. In other embodiments, the material for the cover is a harder durometer than the skate wheel, while in yet other embodiments, the wheel cover includes at least a first and second layer of differing durometers.

In particular, FIG. 1 illustrates a side view of wheel cover 101 and inner surface 103 and outer surface 104. Inner surface 103 contacts an exterior surface of the wheel in a friction fit such that the inner surface 103 mates tightly with the exterior surface of the wheel. Outer surface 104 then contacts the ground while the skateboard is in operation.

FIG. 2 illustrates an embodiment of the invention including a plurality of attachment devices disposed around a periphery of the wheel cover. As seen in FIG. 2, two attachment members 205, 210 stretch between opposing chords and attachment points 220, 225, 230, 235 of the periphery of the wheel cover and secure the wheel cover to the wheel and reduce the incidence of slipping from the wheel. Although two attachment members are illustrated in FIG. 2, any number may be used. FIG. 3 illustrates another embodiment, wherein two attachment members 310, 320 extend between only three attachment points 350, 355, 360. FIG. 4 illustrates four attachment members 460, 462, 464, 468 extending between four attachment points 470, 472, 474, 476.

In one embodiment, three attachment devices are incorporated around the circumference of the cylinder. In one such embodiment, the three attachment devices are positioned approximately equal distances from each other. In another such embodiment, the first attachment device is offset from the second attachment device by a first distance, the first attachment device is offset from the third attachment device by the first distance, and the second attachment device is offset from the third attachment device by a second distance, such that the first distance is not equal to the second distance. In other embodiments, 4 attachment devices are incorporated around the circumference such that a first attachment device is offset from a second attachment device by a first distance, a third attachment device is offset from a fourth attachment device by the first difference, and the first attachment device is offset from the third attachment device by a second distance and the second attachment device is offset from the fourth attachment device by the second distance, and the first distance is different than the second distance. In other 4 attachment device embodiments, each attachment device is offset from the neighboring attachment devices by the same distance.

In one embodiment, the attachment devices include a hole or other such fastener, for connecting a first attachment device and second attachment device with a connecting device. The connecting device may be a thread or string, a metallic hook, or other such retaining device. The connecting device may snap on using a snap, hook-and-latch fastener, zipper, or the like. The connecting device may attach between two attachment devices, or multiple connecting devices can attach between multiple attachment devices. The connecting device is made of any material intended to resist the rotation of the attachment device away from the connecting device itself. The connecting device may resist the wheel unintentionally being separated from the cover. Multiple connecting devices may attach to an individual attachment device in certain embodiments.

In yet other embodiments, the attachment device may include a spring loaded metallic pin that retracts to allow placement of the cover over a wheel, and upon placement extend to lock the cover over the wheel. Alternatively, other devices to lockingly engage a metallic pin, such as retracting latches may be used. In yet other embodiments, the attachment device includes a pin or spike that extends into a wheel well of the wheel itself.

In yet other embodiments, the connecting device includes a rubber, or other such flexible material, band extending between attachment devices.

In another embodiment, the cover includes at least a first rib. The rib may be positioned circumferentially perpendicular to an axis defined by the cylinder. Alternatively, or additionally, the rib may be circumferential and parallel with an axis defined by the cylinder. The rib may be formed from any appropriate material such as a polymer, metal, or the like.

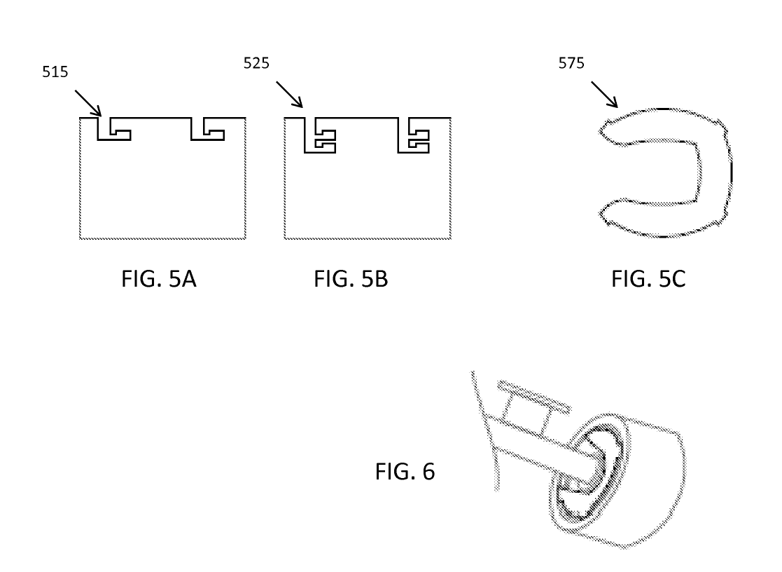

FIGS. 5A, 5B, and 5C illustrate another embodiment of the invention, wherein the invention comprises a system. FIGS. 5A and 5B illustrate an embodiment of the wheel cover wherein the outer periphery of the wheel cover includes a notch—as illustrated a first notch and a second notch. The notch can assume any number of design variations, examples of which are illustrated in FIG. 5A and FIG. B. FIG. 5C illustrates an embodiment of a substantially rigid connector shaped to mate with at least the first notch and second notch, wherein the substantially rigid connector 575 occupies at least a portion of the area defined by the circumferential lip. Also, as illustrated the first notch and second notch in each illustration includes a similar design, although this is not required by the invention. As seen in FIG. 5A and FIG. 5B, there are only two notches illustrated, although any number of notches may be used. FIG. 6 illustrates the system of FIGS. 5A, 5B and 5C disposed on a wheel with an axle, and includes four notches. The substantially rigid connector 575 illustrated in FIG. 5C comprises a “c” shape although other shapes are possible. The substantially rigid connector 575 may be made from any material sufficiently rigid to resist bending, but in one embodiment is made from a steel.

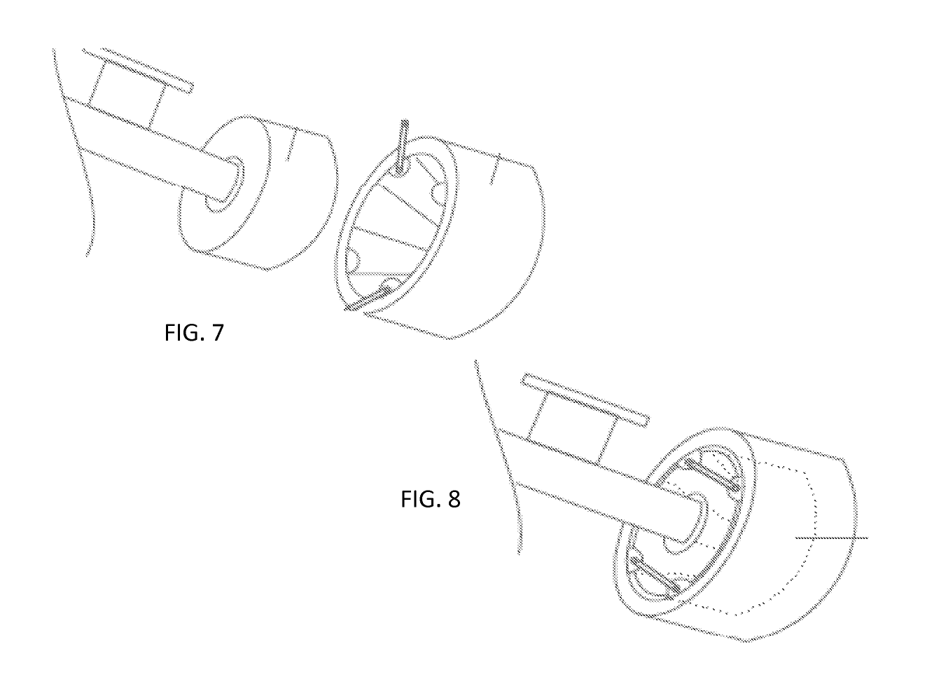

FIG. 7 and FIG. 8 graphically illustrate a method of attaching the wheel cover in accordance with FIGS. 1-4. FIG. 7 illustrates the wheel cover distant from the wheel, whereas the wheel cover is surrounding and attached to the wheel in FIG. 8.

In one embodiment, three attachment devices are incorporated around the circumference of the cylinder. In one such embodiment, the three attachment devices are positioned approximately equal distances from each other. In another such embodiment, the first attachment device is offset from the second attachment device by a first distance, the first attachment device is offset from the third attachment device by the first distance, and the second attachment device is offset from the third attachment device by a second distance, such that the first distance is not equal to the second distance. In other embodiments, 4 attachment devices are incorporated around the circumference such that a first attachment device is offset from a second attachment device by a first distance, a third attachment device is offset from a fourth attachment device by the first difference, and the first attachment device is offset from the third attachment device by a second distance and the second attachment device is offset from the fourth attachment device by the second distance, and the first distance is different than the second distance. In other 4 attachment device embodiments, each attachment device is offset from the neighboring attachment devices by the same distance.

In one embodiment, the attachment devices include a hole or other such fastener, for connecting a first attachment device and second attachment device with a connecting device. The connecting device may be a thread or string, a metallic hook, or other such retaining device. The connecting device may snap on using a snap, hook-and-latch fastener, zipper, or the like. The connecting device may attach between two attachment devices, or multiple connecting devices can attach between multiple attachment devices. The connecting device is made of any material intended to resist the rotation of the attachment device away from the connecting device itself. The connecting device may resist the wheel unintentionally being separated from the cover. Multiple connecting devices may attach to an individual attachment device in certain embodiments.

In yet other embodiments, the attachment device may include a spring loaded metallic pin that retracts to allow placement of the cover over a wheel, and upon placement extend to lock the cover over the wheel. Alternatively, other devices to lockingly engage a metallic pin, such as retracting latches may be used. In yet other embodiments, the attachment device includes a pin or spike that extends into a wheel well of the wheel itself.

In yet other embodiments, the connecting device includes a rubber, or other such flexible material, band extending between attachment devices.

In another embodiment, the cover includes at least a first rib. The rib may be positioned circumferentially perpendicular to an axis defined by the cylinder. Alternatively, or additionally, the rib may be circumferential and parallel with an axis defined by the cylinder. The rib may be formed from any appropriate material such as a polymer, metal, or the like.

Thus, the wheel cover includes an outer portion for contacting the ground, an inner portion for contacting the wheel, a lip for covering a radial portion of an outer part of the wheel, and at least one attachment device to releasably attach the cover to the wheel.

The sizing of the wheel cover is a function of the size of the wheel to be attached to, and a number of sizes are anticipated. Often skateboard wheels typically extend between about 40-70 mm, but this should not be construed as a limitation or an element of the claims.

While the embodiments of the invention disclosed herein are presently considered to be preferred, various changes and modifications can be made without departing from the spirit and scope of the invention. The scope of the invention is indicated in the appended claims, and all changes and modifications that come within the meaning and range of equivalents are intended to be embraced therein.

What is claimed is:

1. A cover for use in combination with a skateboard wheel, wherein the apparatus comprises:
at least a first outer surface and a first inner surface, the first inner surface adapted to contact a wheel outer surface;
at least a first circumferential lip extending along at least a first portion of the tire apparatus on an outer side of the cover; and
at least a first attachment member extending radially along at least a second portion of the cover on an inner side of the apparatus, wherein the second portion is less than one half of the circumference.

2. The cover of claim 1 further comprising at least a second attachment member extending radially along at least a third portion of the cover on an inner side of the skateboard wheel, wherein the third portion is less than one half of the circumference.

3. The cover of claim 2 further comprising at least a first connector adapted to attach the first attachment member and second attachment member to resist expansion of the diameter of the cover.

4. The cover of claim 1 wherein the first attachment member is adapted to engage the wheels.

5. The cover of claim 4 wherein the first attachment member further comprises an elongated hollow cylindrical housing including an open inboard end; a closed outboard end; and interior walls which are dimensioned to receive and frictionally engage the periphery of the wheels.

6. A skateboard wheel cover comprising:
a circumferential lip;
an inner surface connected to an inner portion of the circumferential lip;
an outer surface connected to an outer portion of the circumferential lip, wherein the outer surface comprises a material with a first durometer other than a second durometer of the wheel; and
at least a first attachment device configured to selectively attach to a skateboard wheel.

7. The cover of claim 6 wherein the cover comprises at least one of urethane and rubber.

8. The cover of claim 6 wherein the first attachment device comprises at least a first attachment member extending radially from the outer surface.

9. The cover of claim 6 comprising a first attachment device, second attachment device, and a third attachment device, wherein the first attachment device, second attachment device, and a third attachment device are offset from each other.

10. The cover of claim 9 wherein the first attachment device, second attachment device, and a third attachment device are offset by an equal distance.

11. The cover of claim 9 wherein the first attachment device is offset from the second attachment device by a first distance, the first attachment device is offset from the third attachment device by the first distance, and wherein the second attachment device is offset from the third attachment device by a second distance, and wherein the first distance is not equal to the second distance.

12. A skateboard wheel cover system comprising:
a circumferential lip including at least a first notch and second notch;
an inner surface connected to an inner portion of the circumferential lip;
an outer surface connected to an outer portion of the circumferential lip, wherein the outer surface comprises a material with a first durometer other than a second durometer of the wheel; and
a substantially rigid connector shaped to mate with at least the first notch and second notch, wherein the substantially rigid connector occupies at least a portion of the area defined by the circumferential lip.

13. The system of claim 12 wherein the cover comprises at least one of urethane and rubber.
